(19) United States
(12) Patent Application Publication
(10) Pub. No.: US 2013/0049925 A1
(43) Pub. Date: Feb. 28, 2013

(54) ADJUSTABLE-ORIENTATION RFID TAG READER SYSTEMS AND METHODS OF THEIR OPERATION

(71) Applicant: Panchapakesan V. SUBRAMANIAN, Frederick, MD (US)

(72) Inventor: Panchapakesan V. SUBRAMANIAN, Frederick, MD (US)

(73) Assignee: SYMBOL TECHNOLOGIES, INC., Holtsville, NY (US)

(21) Appl. No.: 13/214,823

(22) Filed: Aug. 22, 2011

(51) Int. Cl. G05B 23/02

(52) U.S. Cl. 340/3.1

(57) ABSTRACT

Embodiments include a radio frequency identification (RFID) tag reader system and methods of its operation. The system includes a drive system and an RFID tag reader. The RFID tag reader includes a directional antenna configured to receive RF signals within a radiowave beam (e.g. RFID tag response signals from RFID tags when the RFID tags are within an area encompassed by the radiowave beam). An embodiment of the system also includes a camera configured to capture images within a field of view. The drive system is coupled to the directional antenna and the camera, and is configured to change physical orientations of the directional antenna and the camera with respect to a fixed coordinate system, resulting in adjustments to angular orientations of the radiowave beam and the field of view with respect to the fixed coordinate system.

### TECHNICAL FIELD

Embodiments of the present invention generally relate to radio frequency identification (RFID) tag reader systems and methods of their operation.

### BACKGROUND

Maintaining an understanding of current inventory is an important aspect of retail sales operations. Accordingly, various inventory-taking systems and processes have been employed, over the years, to assist retail store personnel in determining accurate estimates of current inventory. These systems and processes have included manual counting processes and handheld scanner based systems (e.g. barcode scanner systems and, more recently, systems that employ RFID technology). Manual counting processes are time consuming and prone to human error. When compared with manual counting processes, handheld scanner based systems have produced significant gains in efficiency and accuracy.

In a system that employs RFID technology, an RFID tag is applied to each article for which inventory tracking is desired. The RFID tag is capable of transmitting an information-bearing, radio frequency signal, which may be detected by an RFID tag reader. The information within the RFID tag signal typically includes an identification number that may be correlated with a particular item of inventory. In order to take a full inventory within a retail store space, store personnel with handheld RFID tag readers make rounds through the store and, at various locations, control the RFID tag reader in a manner that causes the RFID tag reader to detect any RFID tags that may be within range of the RFID tag reader. The information collected by the RFID tag reader may then be analyzed to generate an estimate of the current inventory.

An RFID-based system has the benefit of increased efficiency and/or accuracy, when compared with traditional manual inventory-taking processes and barcode scanning systems. For example, manual inventory-taking processes are prone to human error, and barcode scanning systems typically require the individual who is taking inventory to physically handle each tag in order to scan its barcode. In contrast, an RFID tag reader accurately can read identification information for an RFID tag without physical handling of the RFID tag, and the RFID tag reader may be able to receive simultaneous responses from multiple RFID tags within its range.

Although the use of RFID technology has increased the efficiency and accuracy associated with an inventory taking process, the process still takes dedicated human resources and a significant amount of time to complete. Accordingly, even with RFID systems, a retail store may take inventory relatively infrequently (e.g. perhaps once a month, once a week, or less often). In addition, none of the above-described systems enable store personnel readily to determine the locations of particular articles within the store. Inaccurate knowledge of current inventory may, in some circumstances, lead to lost sales and less-than-optimal customer satisfaction due to unavailability of desired articles or sizes and/or the inability to locate desired articles, for example. Accordingly, what are needed are inventory monitoring systems that enable inventory to be taken accurately and more often than is practicable with conventional, handheld scanner based inventory systems. Further needed are inventory monitoring systems that enable specific articles readily to be located within a retail store or other controlled area.

### BRIEF DESCRIPTION OF THE DRAWINGS

Embodiments of the present invention will hereinafter be described in conjunction with the following drawing figures, wherein like numerals denote like elements, and

FIG. 1 is a top view of a simplified depiction of an RFID tag reader system deployed in a controlled area, in accordance with an example embodiment;

FIG. 2 is a side view of the RFID tag reader system of FIG. 1 along line 2-2, in accordance with an example embodiment;

FIG. 3 is a simplified block diagram of an RFID tag reader system coupled with an external system, in accordance with an example embodiment;

FIG. 4 is a flowchart of a method for operating an RFID tag reader system, in accordance with an example embodiment; and

FIG. 5 is a flowchart of a method for updating inventory information, in accordance with an example embodiment.

### DETAILED DESCRIPTION

Embodiments include “adjustable-orientation” RFID tag reader systems and methods of their operation. Unlike the handheld RFID tag readers previously described, an RFID tag reader of an embodiment may be positioned at a fixed location within a controlled area in which RFID tag detection capabilities are desired, and the RFID tag reader may be operated using computer control. The RFID tag reader may receive identification information from RFID tags that are within range of the RFID tag reader, where the range corresponds to the maximum distance at which an RFID tag may be located while still being detectable. When the range of a single RFID tag reader is not sufficient to provide complete RFID tag detection coverage of the entire controlled area, additional RFID tag readers may be positioned in other locations in the controlled area. The RFID tag readers may report the RFID tag identifying data to an external system (e.g. an external inventory monitoring system), and the external system may combine the reported RFID tag identifying data from all of the RFID tag readers to generate and maintain a comprehensive list of detected RFID tags. When setting up such a system, the detection range of each RFID tag reader is taken into account when determining the number and placement of RFID tag readers within the controlled area. Desirably, the number and placement of the RFID tag readers is such that full RFID tag detection coverage of the controlled area is achieved.

The detection range of an RFID tag reader depends on the gain of the RFID tag reader's antenna. Conventional RFID tag readers include non-directional antennas with gains in a range of about 6 dBi (decibels isotropic, which provides a measurement of the forward gain of an antenna). Although such conventional RFID tag readers may be capable of detecting RFID tags essentially in all directions, the range of such RFID tag readers is relatively short (e.g. about 10 to 20 feet).

In contrast, and according to an embodiment, an RFID tag reader includes a directional, high-gain antenna that has a significantly farther range than a conventional RFID tag reader. The high-gain antenna has a significantly more narrow and focused radiowave beam within which RFID tags may be detected, when compared with a non-directional antenna employed in a conventional RFID tag reader. This radiowave beam is referred to herein as a “detection beam” or simply “beam.” The relatively narrow detection beam of the high gain antenna of an RFID tag reader of an embodiment is compensated for by physically coupling the high-gain antenna with a mechanism for dynamically adjusting the orientation of the high-gain antenna (referred to herein as an “orientation adjustment mechanism”), and thus the direction of the detection beam associated with the high-gain antenna.

As will be described in detail below, the orientation of the RFID tag reader antenna is controlled so that its detection beam scans through an area that is larger than the area encompassed by the detection beam. Because the detection range of the high-gain antenna of an embodiment of an RFID tag reader may be significantly farther than the detection range of a conventional RFID tag reader, the dynamic control of the RFID tag reader antenna enables a single RFID tag reader to detect RFID tags within a significantly larger area than can be achieved using a conventional RFID tag reader.

According to a further embodiment, a camera may be mounted with the RFID tag reader antenna to the orientation adjustment mechanism. By coupling the camera to the orientation adjustment mechanism, the camera may be operated as a pan-tilt (PT) camera. When the camera also has zoom capabilities, the camera may be operated as a pan-tilt-zoom (PTZ) camera.

According to an embodiment, the camera and RFID tag reader antenna may be mounted to the orientation adjustment mechanism so that the field of view of the camera and the detection beam of the RFID tag reader antenna completely or partially overlap. In such an embodiment, image information captured by the camera and RFID tag identification information captured by the RFID tag reader may be correlated in time and space, which provides for a number of advantages, as will be described in more detail below.

According to a still further embodiment, one or more of such RFID tag readers may be coupled with an external system, such as an inventory monitoring system, a security system, or another type of system. The external system may be configured to control the times when RFID tag detection processes are performed and when image information is captured. In addition, the external system may be configured to dynamically control the orientation of the RFID tag reader antenna (and the camera, when it is included with the RFID tag reader antenna) and camera, and to adjust the zoom setting and other operational features of the camera.

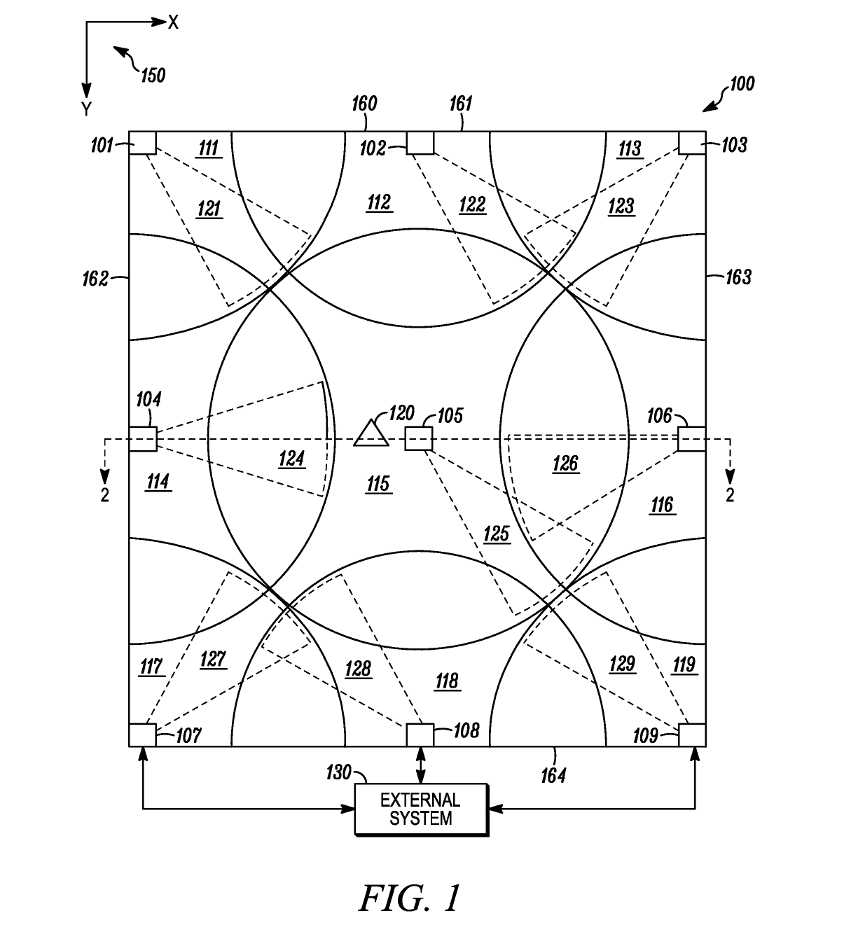

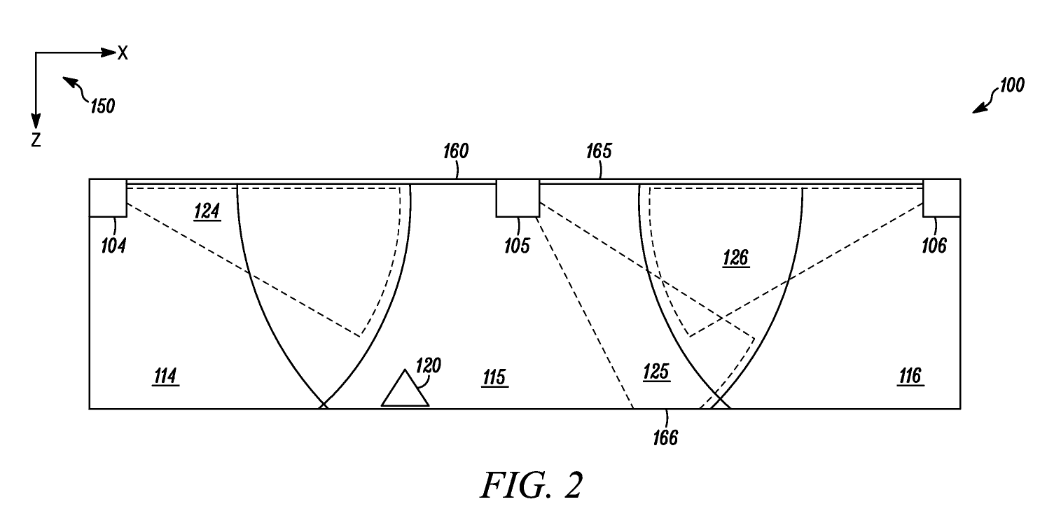

FIG. 1 is a top view of a simplified depiction of an RFID tag reader system 100 deployed in a controlled area 160, in accordance with an example embodiment. FIG. 1 should be viewed in conjunction with FIG. 2, which is a side view of the RFID tag reader system 100 of FIG. 1 along line 2-2, in accordance with an example embodiment. System 100 includes a plurality of RFID tag readers 101, 102, 103, 104, 105, 106, 107, 108, 109 deployed in a controlled area 160, one or more RFID tags 120, and an external system 130 communicatively coupled with the plurality of RFID tag readers 101-109. Although nine RFID tag readers 101-109 are illustrated in FIG. 1, the number of RFID tag readers 101-109 may be any integer number, N, where N may be from 1 to potentially hundreds of RFID tag readers 101-109. In addition, although only one RFID tag 120 is illustrated in FIG. 1, the number of RFID tags 120 may be any integer number, M, where M may be from 1 to potentially thousands of RFID tags 120.

The controlled area 160 may be defined, for example, by one or more walls 161, 162, 163, 164 (FIG. 1), a ceiling 165 (FIG. 2), and a floor 166 (FIG. 2), although the controlled area 160 need not be so defined. RFID tag readers 101-109 are positioned in fixed locations throughout the controlled area 160. For example, as indicated in FIG. 2, RFID tag readers 101-109 are affixed to the ceiling 165 of the controlled area 110. However, this is not a necessity. In other example configurations, an RFID tag reader may be affixed to the floor, to a wall, to a shelf, to a post, or to any other point within a controlled area. Further, although a controlled area 160 having a substantially rectangular shape is depicted in FIG. 1, and the RFID tag readers 101-109 are shown to provide complete coverage of the controlled area 160, embodiments of the inventive subject matter may be used in any size or shape of controlled area 160, and/or the controlled area may not be bound by walls, and/or the RFID tag readers may be deployed so that only partial coverage of the controlled area is established.

Each RFID tag reader 101-109 is configured to detect the presence of any RFID tags 120 that are located within a detection area associated with the RFID tag reader 101-109 (e.g. detection areas 111, 112, 113, 114, 115, 116, 117, 118, 119), and to transmit RFID tag identifying data for each detected RFID tag 120 to external system 130. As mentioned previously and as will be described in more detail later, each RFID tag reader 101-109 includes at least one directional antenna (not illustrated), which is configured to receive RF signals (e.g. RFID tag response signals) within a detection beam 121, 122, 123, 124, 125, 126, 127, 128, 129. The directional antennas included in RFID tag readers 101-109 are sufficiently high gain so that the detection beams 121-129 have relatively narrow beam widths. For example, the beam widths of the detection beams 121-129 may be such that each detection beam 121-129 only partially encompasses the associated detection area 111-119 for each RFID tag reader 101-109. For example, RFID tag reader 105 includes a directional antenna associated with detection beam 125, and detection beam 125 has a beam width that is too narrow to cover the entire detection area 115 associated with RFID tag reader 105. As will be described in more detail below, and according to an embodiment, the orientation of the directional antenna of RFID tag reader 105 may be dynamically adjusted to ensure that the detection beam 125 pans across and through substantially all of the detection area 115. Accordingly, although the detection beam 125 is too narrow to cover the entire detection area 115 at any given instant, by dynamically moving the directional antenna (and thus the detection beam 125), the detection beam 125 may be controlled to cover the entire detection area 115 over a period of time.

According to an embodiment, in order to provide for dynamic adjustment of the orientation of the directional antenna of each RFID tag reader 101-109, each directional antenna is coupled with a drive system (not illustrated in FIG. 1) that is configured to change the physical orientation of the directional antenna with respect to a fixed coordinate system 150. This results in adjustments to an angular orientation of each detection beam 121-129 with respect to the fixed coordinate system 150. In other words, the drive system may be controlled to cause each detection beam 121-129 to be rotated across an entire detection area 111-119. This enables an RFID tag 120 located anywhere within a detection area 111-119 to be detected, despite the narrowness of the detection beam 121-129. For example, although RFID tag 120 is not shown to be within the detection beam 125 of RFID tag reader 105 in either FIG. 1 or FIG. 2, the drive system associated with RFID tag reader 105 may rotate the directional antenna, and thus the detection beam 125, to be coincident with the location of RFID tag 120, thus enabling detection of RFID tag 120.

From the perspective of FIG. 1 (i.e. a top view of controlled area 160), assume that the fixed coordinate system 150 is defined by an x-axis (as shown in FIGS. 1 and 2), a y-axis (as shown in FIG. 1), and a z-axis (as shown in FIG. 2). By controlling the drive system of RFID tag reader 105, the directional antenna and detection beam 125 may be rotated around the z-axis through a range of rotation (e.g. 360 degrees to cover the entire portion of detection area 115 that is co-planar with the x-y plane). Referring also to FIG. 2, the drive system of RFID tag reader 105 may be further controlled to rotate the directional antenna and detection beam 125 around the y-axis through a range of rotation (e.g. 180 degrees to cover the portion of detection area 115 that is co-planar with the x-z plane and below the ceiling 165 of the controlled area 160). In addition, the drive system of RFID tag reader 105 may be further controlled to rotate the directional antenna and detection beam 125 around the x-axis through a range of rotation, even though a separate figure is not included to depict such an embodiment for purposes of conciseness. Basically, the drive system associated with any particular RFID tag reader 101-109 may be controlled to rotate the directional antenna (and thus the detection beam 121-129) of the RFID tag reader 101-109 around one or more axes of a fixed coordinate system 150.

The range of rotation (about any particular axis) through which a drive system may rotate a directional antenna and detection beam 121-129 may be pre-defined based on the placement of the RFID tag reader 101-109 (or more specifically, the tag reader's directional antenna) within the controlled area 160. For example, referring again to FIG. 1, RFID tag readers 101, 103, 107, and 109 each are placed in a corner of the controlled area 160. Accordingly, for RFID tag readers 101, 103, 107, and 109, the range of rotation about the z-axis may be pre-defined to be approximately 90 degrees. Conversely, RFID tag readers 102, 104, 106, and 108 each are placed along a wall 161-164. Accordingly, for RFID tag readers 102, 104, 106, and 108, the range of rotation about the z-axis may be pre-defined to be approximately 180 degrees. Finally, RFID tag reader 105 is placed in a central portion of controlled area 160. Accordingly, the range of rotation about the z-axis for RFID tag reader 105 may be pre-defined to be 360 degrees. Referring again to FIG. 2, the range of rotation about the y-axis for RFID tag readers 104, 106 may be pre-defined to be approximately 90 degrees, whereas the range of rotation about the y-axis for RFID tag reader 105 may be pre-defined to be approximately 180 degrees. The range of rotation about the x-axis may be similarly defined.

The range of rotation of each RFID tag reader 101-109 may be established locally within each RFID tag reader 101-109, or may be controlled by external system 130. According to an embodiment, the external system 130 communicates control signals to the orientation adjustment mechanism of each RFID tag reader 101-109 to dynamically control the orientation of each directional antenna. In an embodiment, RFID tag readers 101-109 and external system 130 communicate wirelessly over RF communication links, although this is not a requirement. In an alternate embodiment, some or all of RFID tag readers 101-109 may communicate over wired connections with external system 130. Either way, external system 130 may be considered to be a remote processing system, with respect to RFID tag readers 101-109, in that external system 130 can be remotely located from RFID tag readers 101-109, although this is not a requirement. External system 130 is communicatively coupled with each of RFID tag readers 101-109, even though external system 130 is shown to be coupled only with RFID tag readers 107-109 in order to simplify FIG. 1.

According to an embodiment, system 100 supports various types of communications between external system 130 and RFID tag readers 101-109: control signals from external system 130 to RFID tag readers 101-109, as mentioned above; and RFID tag identifying data from RFID tag readers 101-109 to external system 130. As will be described in more detail later, the RFID tag reader control information may include polling parameters, such as the times, frequencies, and/or durations of polling operations to be performed by the RFID readers 101-109. In addition, the polling parameters may include polling antenna selections and polling antenna activation durations, among other things. The control signals from external system 130 to RFID tag readers 101-109 also may include signals that dynamically control the orientation adjustment mechanisms of each of the RFID tag readers 101-109. More specifically, the external system 130 may provide signals to an orientation adjustment mechanism to which a directional antenna of an RFID tag reader 101-109 is affixed, in order to change the angular orientation of the detection beam with respect to fixed coordinate system 150. In an embodiment in which a camera also is coupled to each orientation adjustment mechanism, additional control signals from external system 130 may control when the camera actively captures images, the zoom level for image capture, and other controllable settings relating to image capture.

The RFID tag identifying data sent from the RFID tag readers 101-109 to the external system 130 identifies RFID tags 120 that responded to polling operations conducted by the RFID tag readers 101-109. The RFID tag identifying data enables the external system 130 to establish or maintain knowledge of all detectable RFID tags 120 that are within the controlled area 160. In addition, in an embodiment in which a camera is coupled with each orientation adjustment mechanism, the camera may communicate image data to the external system 130. Each orientation adjustment mechanism may communicate angular orientation data indicating the angular orientation of the RFID tag reader's directional antenna and the camera (and thus the detection beam and/or camera field of view) with respect to the fixed coordinate system 150. According to an embodiment, the RFID tag identifying data, the image information, and the angular orientation data may be correlated in time, as will be described in more detail later.

External system 130 may be, for example, an inventory monitoring system, a security system, or any of a variety of systems that may benefit from the RFID technologies (and possibly the imaging technologies) employed in the various embodiments. For purposes of example, the remainder of the description below describes the external system 130 as being an inventory monitoring system. However, the description of an embodiment in which external system 130 is an inventory monitoring system should not be construed as limiting the scope of the inventive subject matter to a system that includes an inventory monitoring system. Instead, various types of external systems 130 may be used in conjunction with the various embodiments.

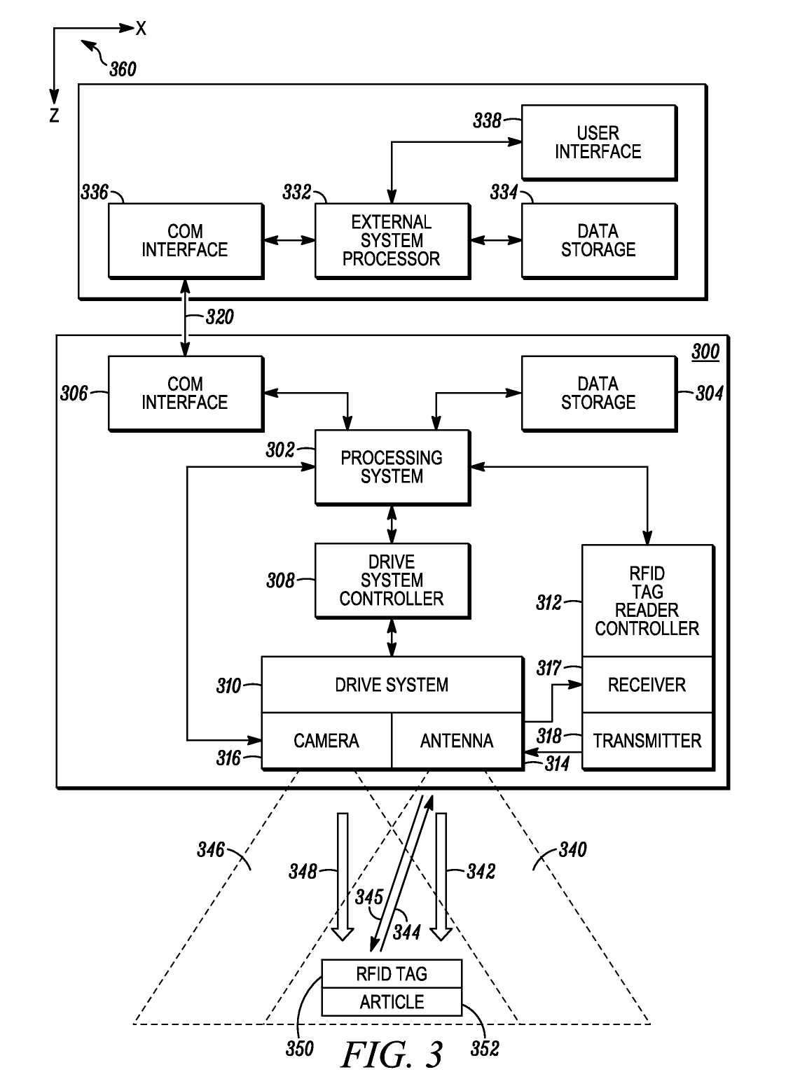

FIG. 3 is a simplified block diagram of an RFID tag reader system 300 coupled with an external system 330, in accordance with an example embodiment. For purposes that will be discussed in more detail later, RFID tag reader system 300 and external system 330 exchange various data and control signals 320 via communications (COM) interfaces 306, 336, respectively.

Communications interfaces 306, 336 may be wired or wireless (i.e., RF) interfaces, which may implement any of a number of communications protocols.

RFID tag reader system 300 includes processing system 302, data storage 304, communications interface 306, an RFID tag reader, and an orientation adjustment mechanism. As will be described in more detail later, processing system 302 is configured to coordinate the operations of the RFID tag reader, the orientation adjustment mechanism, and in some cases, a camera 316, based on control signals received from an external system 330 via communications interface 306. In addition, processing system 302 is configured to coordinate transmission of various types of data to the external system 330 via the communications interface 306, where the data may include one or more types of data selected from a group consisting of RFID tag identifying data (from the RFID tag reader), angular orientation date (from the orientation adjustment mechanism), and image data (from camera 316).

In general, the RFID tag reader is configured to detect the presence of RFID tags (e.g. RFID tag 350) within a detection beam 340. According to an embodiment, the RFID tag reader includes an RFID tag reader controller 312, an antenna 314 (e.g. a directional antenna), and a receiver 317. Antenna 314 is configured to receive RF signals (e.g. RFID tag response signal 344 from RFID tag 350) within the detection beam 340. Antenna 314 is a directional antenna (i.e. a high gain antenna), in an embodiment, which has a gain in a range of 8 to 15 dBi. Receiver 317 is coupled to the antenna 314, and is configured to convert the RFID tag response signal 344 into RFID tag identifying data. In an embodiment in which the RFID tag reader is configured to detect the presence of passive RFID tags (described below), the RFID tag reader may further include a transmitter 318.

RFID tag reader controller 312 executes an RFID tag detection algorithm. The particular RFID tag detection algorithm depends on the type of RFID tag employed in the system. For example, in various embodiments, the RFID tag detection algorithm is configured to communicate with an RFID tag 350 selected from a group consisting of an active RFID tag, a passive RFID tag, and a battery-assist passive RFID tag. The RFID tag 350 may be coupled with an article 352, such as an item of inventory. Alternatively, the article 352 may be a person, an animal, or some other type of object to which an RFID tag 350 may be attached.

Each of the above-mentioned types of RFID tags includes an integrated circuit for storing information (e.g. a tag and/or article identifier), processing RFID tag interrogation signals from an RFID tag reader, and transmitting an RFID tag response signal 344 that includes the stored identification information. An RFID tag 350 also may be programmable to store other information, such as the transaction status of an article 352 to which the RFID tag 350 is attached (i.e. whether the article is “transacted” (paid-for and sold) or “non-transacted” (not yet paid for or sold)). When an RFID tag 350 initially is attached to an article 352 and offered for sale, the transaction status may be initialized to “non-transacted,” and when the article is sold, equipment at the point-of-sale may be used to change the stored transaction status to “transacted.”

An active RFID tag 350 includes a battery, and is capable of transmitting a signal (e.g. tag response signal 344) autonomously. In contrast, a passive RFID tag 350 does not include a battery, and requires a tag interrogation signal (e.g. tag interrogation signal 345) from an external source (e.g. the RFID tag reader) to provoke transmission of a tag response signal 344. A battery-assisted passive RFID tag 350, on the other hand, still requires an external source to invoke the tag to transmit a tag response signal 344, but the battery enables the RFID tag 350 to have a significant higher forward link capability than non-battery-assisted passive RFID tags, thus providing greater range.

According to an embodiment, an RFID tag detection algorithm is implemented by RFID tag reader controller 312. For passive RFID tags, the tag detection algorithm includes invoking transmitter 318 to transmit a tag interrogation signal 345 via antenna 314, and attempting to detect a tag response signal 344 from an RFID tag 350 via antenna 314 and receiver 317. For active RFID tags which transmit a tag response signal 344 automatically (i.e. not in response to an interrogation signal), transmitter 318 may be excluded from the RFID tag reader.

The RFID tag detection algorithm also may include evaluating RFID tag response signals 344 received via receive antenna 314 and receiver 317 to determine whether they are valid RFID tag response signals. In addition, in an embodiment, the RFID tag detection algorithm is configured to provide information received in or derived from the RFID tag response signals to external system 330 when an RFID tag 350 associated with (e.g. attached to) a particular article has been detected, thus indicating that an article 352 to which the RFID tag 350 is attached may be within a controlled area (e.g. controlled area 160, FIG. 1). For example, the information received in an RFID tag response signal 344 may include an RFID tag identifier or an article identifier (e.g. a SKU of the article 352 to which the responding RFID tag 350 is attached). The RFID tag detection algorithm may cause the RFID tag reader system 300 to send information that indicates the identity of the RFID tag 350 or article 352 to the external system 330, when it is determined that the RFID tag 350 is in range of the RFID tag reader. The information sent from the RFID tag reader system 300 to the external system 330 is referred to herein as “RFID tag identifying data,” which essentially includes any data derived based on an RFID tag response signal 344 that indicates the identity of an RFID tag (e.g. RFID tag 350) or an article to which the RFID tag is attached (e.g. article 352).

In an embodiment, the information received in an RFID tag response signal also may include the stored transaction status of the item (e.g. transacted or non-transacted), and the RFID tag detection algorithm may indicate to the external system 330 whether or not the article 352 was properly purchased. In other words, the RFID tag reader system 300 may report the transaction status stored in the RFID tag 350 to the external system 330. The RFID tag reader controller 312 reports the RFID tag identifying data and the transaction status to the external system 330 via processing system 302 and communications interface 306, in an embodiment.

In a further embodiment, the RFID tag reader system 300 also includes a camera 316. Camera 316 is configured to capture still or video images within a field of view 346, and to produce image data corresponding to the images. Camera 316 may report the image data to the external system 330 via processing system 302 and communications interface 306, in an embodiment. Camera 316 may have a zoom capability (i.e. the ability to provide image data with increased resolution within a narrower portion of the field of view 346) that is controllable based on control signals received from processing system 302.

The orientation adjustment mechanism includes at least one drive system controller 308 and at least one drive system 310, in an embodiment. The drive system 310 includes one or more controllable servomotors, which control the physical position of an attachment structure (not shown). More specifically, the drive system 310 may cause the attachment structure to be rotated, with respect to a fixed coordinate system 360, about one, two, or three axes, in order to dynamically move the attachment structure in a desired manner or to position the attachment structure in a desired static position.

According to an embodiment, the drive system 310 (or more specifically, the attachment structure) is physically and rigidly coupled to antenna 314. Accordingly, the drive system 310 may be controlled to change a physical orientation of antenna 314 with respect to the fixed coordinate system 360, resulting in adjustments to an angular orientation of the detection beam 340 with respect to the fixed coordinate system 360. For example, as indicated in FIG. 3, the detection beam 340 is aligned in a direction generally indicated by arrow 342, and this direction may be adjusted with respect to the fixed coordinate system 360 through control of drive system 310.

According to an embodiment, camera 316 also is physically and rigidly coupled to the drive system 310 (or more specifically, the attachment structure) so that the physical orientation of camera 316 may be adjusted in concert with adjustments to the physical orientation of antenna 314. Adjustments to the physical orientation of camera 316 result in adjustments to the angular orientation of the field of view 346 of camera 316 with respect to the fixed coordinate system 360. For example, as indicated in FIG. 3, the field of view 346 is aligned in a direction generally indicated by arrow 348, and this direction may be adjusted with respect to the fixed coordinate system 360 through control of drive system 310. When camera 316 has a zoom capability, the combination of the drive system 310 and the camera 316 may be considered to comprise portions of a pan-tilt-zoom (PTZ) camera system.

Drive system 310 is configured to adjust the physical orientation of antenna 314 and camera 316 in a manner that causes the detection beam 340 and field of view 346 to move through pan angle ranges and tilt angle ranges defined with respect to the fixed coordinate system 360 (e.g. to achieve coverage of an entire detection area, as discussed above in conjunction with FIGS. 1 and 2). According to an embodiment, antenna 314 and camera 316 are coupled with the drive system 310 so that the detection beam 340 and the field of view 346 are generally aligned and at least partially overlap each other. In other words, the general directions of alignment of the detection beam 340 and the field of view 346 are substantially parallel (e.g. arrows 342 and 348 are substantially parallel). In such an embodiment, the RFID tag reader and the camera 316 simultaneously may “look at” (i.e. receive RFID tag response signals 344 from and capture images of) the same RFID tag 350 (or tags) and article 352 (or articles). In an alternate embodiment, antenna 314 and camera 316 may be coupled to distinct drive systems that are controlled in coordination with each other to align the detection beam 340 and field of view 346.

As indicated above, the drive system controller 308 is communicatively coupled with the drive system 310, and is configured to provide control signals to the drive system 310 that cause the drive system 310 to change the physical orientations of antenna 314 (and thus detection beam 340) and camera 316 (and thus field of view 346) with respect to the fixed coordinate system 360. Drive system 310 and/or drive system controller 308 are configured to produce angular orientation data indicating the angular orientation of the antenna 314 (and thus detection beam 340) and camera 316 with respect to the fixed coordinate system 360.

Processing system 302 receives the tag or article identity indicating information from the RFID tag reader controller 312, the image data from camera 316, and the angular orientation data from drive system 310 or drive system controller 308, in an embodiment. Some or all of this information may be stored, at least temporarily, in data storage 304. Processing system 302 may then transmit some or all of the received information to external system 330 (via communications interface 306) in a manner that enables external system 330 to correlate the information in time. For example, processing system 302 may timestamp each type of information prior to storage and/or transmission, and/or may otherwise associate tag/article, image, and/or angular orientation information that is received in close temporal proximity. For example, processing system 302 may form a data packet (for transmission) with such temporally proximate information. In an alternate embodiment, one or more of RFID tag reader controller 312, drive system controller 308, and camera 316 may timestamp its own information and send the information to external system 330 via communications interface 306 directly (e.g. without processing system 302 intervening). Either way, the ability of external system 330 to correlate the various types of information produced by RFID tag reader system 300 enables the system 300 to be used for a number of advantageous purposes, some of which are described later.

Each of processing system 302, drive system controller 308, RFID tag reader controller 312, and processing components of camera 316 may include one or more general or special purpose processors and associated memory and other circuitry, which is configured to enable these various system components to carry out their intended functions. Although RFID tag reader controller 312, drive system controller 308, and processing system 302 are depicted as separate processing components in FIG. 3, any combination or all of RFID tag reader controller 312, drive system controller 308, and processing system 302 may be implemented using common processing hardware, as well.

As indicated above, communications interface 306 of RFID tag reader system 300 is an external system interface, which is configured to communicate the RFID tag identifying data, image data, and angular orientation data to external system 330. In a system that includes one or more additional RFID tag readers (e.g. the system of FIGS. 1 and 2), external system 330 is configured to receive RFID tag identifying data, image data, and angular orientation data from the additional RFID tag reader systems, as well.

External system 330 includes external system processor 332, data storage 334, communications interface 336, and user interface 338, in an embodiment. Although external system 330 may be any of a variety of types of systems (e.g. an inventory monitoring system, a security system, and so on), an example of the functionality of external system 330 as an inventory monitoring system is discussed below for purposes of illustrating an example embodiment.

External system processor 332 includes one or more general or special purpose processors and associated memory and other circuitry, which is configured to enable external system processor 332 to provide control signals (via communications interface 336) to RFID tag reader system 300. The various control signals provided by external system processor 332 may include, for example, signals that control the timing and duration of polling operations (i.e. operations performed by the RFID tag reader to attempt to detect RFID tags), signals that control activation and operation of camera 316 (e.g. focus, lighting, zoom settings, and so on), signals that cause the drive system controller 308 to move the antenna 314 and camera 316 to certain positions, and signals that cause the drive system controller 308 to move the antenna 314 and camera 316 through various pan and tilt ranges (at controllable rates), among other things.

In addition, external system processor 332 is configured to process RFID tag identifying data, image data, and angular orientation data received from RFID tag reader system 300 (via communications interface 336). For example, when external system 330 is an inventory monitoring system, external system processor 332 is configured to maintain inventory information (e.g. in data storage 334) regarding quantities of a plurality of articles that are present within a controlled area (e.g. controlled area 160, FIG. 1) based on the RFID tag identifying data received from RFID tag reader system 300. More specifically, in response to receiving tag or article identity indicating information from RFID tag reader system 300 (and possibly the transaction status of the associated article), external system processor 332 may update the inventory information regarding quantities of the article present in the controlled area, in an embodiment.

In addition, because the tag or article identity indicating information may be correlated with angular orientation data, external system processor 332 may be capable of determining specific physical locations of various articles (i.e. of various RFID tags attached to the articles). For example, in an embodiment, the location of RFID tag reader system 300 within a controlled area is known by external system processor 332, along with the installation orientation of the RFID tag reader system 300 (i.e. the fixed orientation of attachment of the RFID tag reader system 300 within the controlled area with respect to the fixed coordinate system 360). In order to determine a location within the controlled area of a particular RFID tag that has been detected by the RFID tag reader system 300, geometrical analysis is performed using the angular orientation data for the RFID tag and the known physical location of the RFID tag reader system 300 to determine, at least, a direction in which antenna 314 was pointing at the time when the RFID tag was detected by the RFID tag reader system 300. The determined direction may be correlated with a particular location within the controlled area. Such a calculation may be further refined when multiple RFID tag reader systems reported detection of the same RFID tag (e.g. when the RFID tag is located in an area in which detection areas of multiple RFID tag reader systems overlap). In such a case, the external system processor 332 may employ triangulation calculations to refine a determination of the location of the RFID tag.

User interface 338, which is communicatively coupled with the external system processor 332, is configured to provide inventory-related information (e.g. representations of inventory) to a human user, and to initiate and/or alter the execution of various processes that may be performed by the RFID tag reader system 300. For example, user interface 338 may be configured to provide a graphical user interface (GUI), which enables a user to view lists or other representations of RFID tags and/or their associated articles that have been detected by RFID tag reader system 300 and other RFID tag reader systems installed in a controlled area. In an embodiment in which external system 330 is an inventory monitoring system, for example, user interface 338 may be configured to provide representation of current inventory (e.g. quantities of articles in inventory, locations of articles in inventory, and so on) in pictorial and/or textual forms. After an inventory has been established (e.g. a plurality of tag and/or article identifiers associated with detected RFID tags in the controlled area has been stored in data storage 334, along with their locations in the controlled area), user interface 338 may be manipulated by the user to convey (e.g. display) inventory information to the user. The inventory information may be conveyed in any of a number of formats, including lists, reports, spreadsheets, and graphical depictions. For example, inventory information may be displayed to the user as a planogram, which provides information about the location of various RFID tags (e.g. RFID tag 350) within the controlled area, including the locations of desired or misplaced articles. For articles that are misplaced, the user interface 338 additionally may display the correct locations for those articles, which enables store personnel to efficiently organize inventory in a desired way. According to an embodiment, the user interface 338 also may display the nature (e.g. type, description, SKU, etc.) and desired location of articles in need of replenishment (e.g. articles for which the inventory has been depleted entirely or to a relatively low level).

In addition, user interface 338 may enable the user to initiate a polling or inventory taking process, and/or to establish or modify parameters relating to polling or inventory taking processes. These parameters may include, for example, times, frequencies, and/or durations of polling operations to be performed by the RFID tag reader of RFID tag reader system 300, pan/tilt rates and ranges to be implemented by drive system controller 308 and drive system 310, control parameters for camera 316 (e.g. zoom settings and whether or not camera 316 is active or inactive during the polling operations), and data capture settings, among other things.

According to a further embodiment, user interface 338 may enable a user to enter information (e.g. an article type, description, SKU, identifier, or RFID tag identifier) that causes the external system 330 to determine and indicate the location of a particular RFID tag (e.g. RFID tag 350) within the controlled area. The determination may be made based on previously stored information associated with the particular RFID tag, or the determination may cause the RFID tag reader system 300 (and possibly one or more other RFID tag reader systems in the controlled area) to perform a polling operation throughout its associated detection area to attempt to detect the particular RFID tag. When the particular RFID tag has been detected and its location within the controlled area determined, the user interface 338 may provide an indication of the location to the user. According to a further embodiment, the user interface 338 may render images of the location of the particular RFID tag, where the images are produced using image data that has been captured by camera 316 and associated (e.g. by processing system 302 and/or external system processor 332) with the RFID tag identifying data for the particular RFID tag.

According to yet a further embodiment, the user interface 338 may enable the user to cause the drive system 310 to move the field of view 346 of camera 316 to a location associated with the particular RFID tag (e.g. a location previously determined based on angular orientation data associated with detecting the particular RFID tag within the detection beam 340 of antenna 314), and to provide real-time images or video during the operation. The user may further manipulate user interface 338 to cause the camera to increase or decrease a zoom setting, in order to zoom in toward or out from the determined location of the particular RFID tag. In this manner, the user interface 338 provides a visualization of the location of the particular RFID tag. When the user interface 338 is located in proximity to a retail store (i.e. the controlled area corresponds to a retail store and the user interface 338 is located at a register or in an office of the retail store), for example, store personnel may be able rapidly to locate a particular article within the retail store (e.g. at the request of a potential customer). The capabilities provided by user interface 338 also may be applied advantageously to locate articles in areas other than retail stores (e.g. warehouses, office buildings, and so on).

In order to provide the above features (and additional features), user interface 338 may include a computer, a monitor, a keyboard, a mouse, a printer, and various other hardware components to provide a man/machine interface. In an embodiment, user interface 338 and external system processor 332 may include distinct hardware components. In such an embodiment, user interface 338 may be co-located or remotely-located from external system processor 332, and accordingly user interface 338 may be operably connected with external system processor 332 via wired, wireless, direct, or networked connections. In an alternate embodiment, user interface 338 and external system processor 332 may utilize some shared hardware components (e.g. processors, memory, and so on).

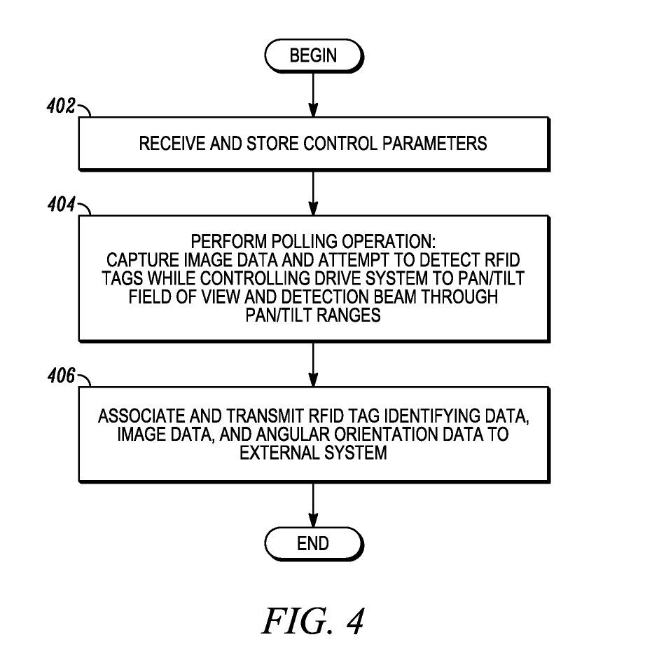

FIG. 4 is a flowchart of a method for operating an RFID tag reader system, in accordance with an example embodiment. The method may be performed, for example, by an RFID tag reader system, such as RFID tag reader system 300, FIG. 3. The method may begin, in block 402, when the RFID tag reader system receives (e.g. from external system 330, FIG. 3) and stores (e.g. in data storage 304, FIG. 3), various control parameters relating to performing polling operations, capturing images, and so on. The control parameters may be intended to invoke the RFID tag reader system to perform polling operations and image capture processes on demand, or may be intended to invoke the RFID tag reader system to perform polling operations and image capture processes at future times. As discussed above, the control parameters may include, but are not limited to, times, frequencies, and/or durations of polling operations to be performed by an RFID tag reader, pan/tilt rates and ranges to be implemented by a drive system controller and drive system, control parameters for a camera, and data capture settings, among other things.

When a time to perform a polling operation has arrived, the polling operation is performed, in block 404. The polling operation is performed in accordance with the received control parameters. According to an embodiment, the polling operation may involve capturing image data (e.g. by camera 316, FIG. 3) and attempting to detect RFID tags (e.g. by RFID tag reader controller 312, antenna 314, receiver 317, and transmitter 318, FIG. 3), while controlling a drive system (e.g. drive system 310, FIG. 3) to pan/tilt the camera field of view (e.g. field of view 346, FIG. 3) and the detection beam (e.g. detection beam 340) through specified pan/tilt ranges, with respect to a fixed coordinate system (e.g. fixed coordinate system 360, FIG. 3). This information may be stored temporarily by the RFID tag reader system (e.g. in data storage 304, FIG. 3).

Said another way, performing a polling operation (e.g. attempting to detect one or more RFID tags) includes changing the physical orientation of a directional antenna of an RFID tag reader (e.g. antenna 314, FIG. 3) with respect to a fixed coordinate system (e.g. fixed coordinate system 360, FIG. 3). Because the directional antenna is configured to receive RF signals within a detection beam (e.g. detection beam 340, FIG. 3), changing the physical orientation of the directional antenna results in adjustments to an angular orientation of the detection beam with respect to the fixed coordinate system. An RFID tag response signal (e.g. signal 344, FIG. 3) may be received from an RFID tag (e.g. RFID tag 350, FIG. 3) when the RFID tag is within an area encompassed by the detection beam. The RFID tag reader produces RFID tag data based on the RFID tag response signal.

Performing the polling operation also may include changing the physical orientation of a camera (e.g. camera 316, FIG. 3) with respect to the fixed coordinate system, resulting in adjustments to an angular orientation of a field of view of the camera (e.g. field of view 346, FIG. 3) with respect to the fixed coordinate system. The camera captures images within the field of view, and produces image data corresponding to the images. The physical adjustments to the angular orientations of the RFID tag reader detection beam and the camera field of view are made simultaneously (e.g. using the same drive system controller 308 and drive system 310, or by using different drive system controllers 308 and/or drive systems 310 operated in coordination), so that the detection beam and the field of view at least partially overlap, and are aligned along parallel directions, in an embodiment.

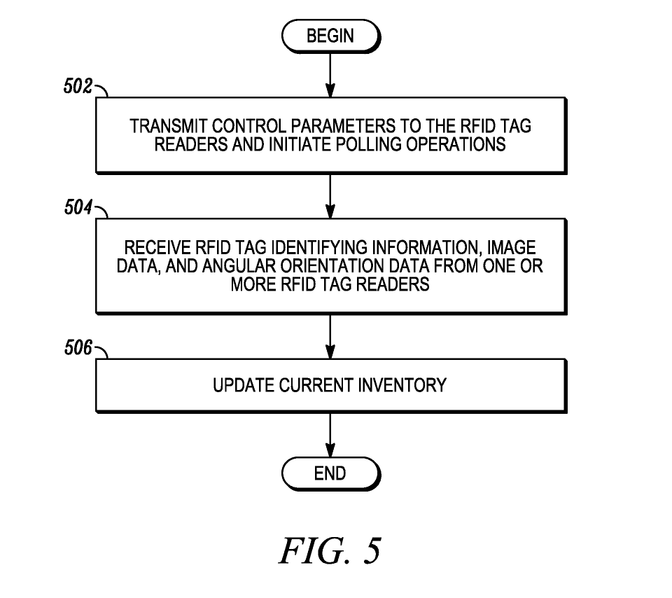

In block 406, the RFID tag reader system may associate the captured image data and RFID tag identifying data with angular orientation data (e.g. angular orientation data received from drive system controller 308 and/or drive system 310). The captured image data, RFID tag identifying data, and angular orientation data may be timestamped and/or packetized together in a manner that enables the captured image data and RFID tag identifying data to be correlated in time and space. The image data, RFID tag identifying data, and angular orientation data may be transmitted (e.g. using communications interface 306, FIG. 3) to an external system (e.g. external system 330, FIG. 3). As indicated previously, the information provided using the above process may be useful for any of a number of purposes, one of which includes maintaining inventory information, as described in conjunction with FIG. 5, below.

FIG. 5 is a flowchart of a method for creating and maintaining inventory information, in accordance with an example embodiment. The method may be performed, for example, by an inventory monitoring system, such as external system 330, FIG. 3. The method may begin, in block 502, by transmitting (e.g. using communications interface 336, FIG. 3) various control parameters to one or more RFID tag reader systems (e.g. RFID tag reader system 300, FIG. 3). As discussed above in conjunction with block 402 of FIG. 4, the control parameters may include various control parameters relating to performing polling operations, capturing images, and so on. Essentially, the transmitted control parameters invoke the RFID tag reader system(s) to capture images in conjunction with performing polling operations to attempt to detect RFID tags within a controlled area, in an embodiment.

In response to transmitting the control parameters, the inventory monitoring system receives (e.g. via communications interface 336, FIG. 3), captured image data, RFID tag identifying data, and angular orientation data, in an embodiment. The received captured image data, RFID tag identifying data, and angular orientation data may be associated by virtue of timestamps, packetization techniques, or other techniques, as discussed previously.

In block 506, the inventory monitoring system may use the received image data, RFID tag identifying data, and angular orientation data from one or more RFID tag reader systems to create or update inventory information regarding quantities of articles within the controlled area, in an embodiment. This may include, for example, consolidating information received from a plurality of RFID tag reader systems, harmonizing redundant information (e.g. RFID tags reported by multiple RFID tag reader systems), removing articles from inventory for which an associated RFID tag has not been detected for a period of time, and so on.

Once a polling operation has been completed (e.g. each RFID tag reader system has captured images and detected RFID tags within its entire detection area, and the corresponding image data, RFID tag identifying data, and angular orientation data has been received), and the inventory has been updated, the method may end. Alternatively, the method may be continuously performed, in order to maintain up-to-date inventory information at all times. Either way, as discussed previously, the inventory information subsequently may be used in a variety of ways (e.g. to provide a snapshot of current inventory, to indicate locations of misplaced articles, to indicate articles in need of replenishment, and so on).

The foregoing detailed description is merely exemplary in nature and is not intended to limit the invention or the application and uses of the invention. Furthermore, there is no intention to be bound by any expressed or implied theory presented in the preceding technical field, background, brief summary or detailed description.

For simplicity and clarity of illustration, the drawing figures illustrate the general manner of construction, and descriptions and details of well-known features and techniques may be omitted to avoid unnecessarily obscuring the invention. Additionally, elements in the drawings figures are not necessarily drawn to scale. For example, the dimensions of some of the elements or regions in some of the figures may be exaggerated relative to other elements or regions of the same or other figures to help improve understanding of embodiments of the invention.

The terms “first,” “second,” “third,” “fourth” and the like in the description and the claims, if any, may be used for distinguishing between similar elements and not necessarily for describing a particular sequential or chronological order. It is to be understood that the terms so used are interchangeable under appropriate circumstances such that the embodiments of the invention described herein are, for example, capable of operation or use in sequences other than those illustrated or otherwise described herein. Furthermore, the terms “comprise,” “include,” “have” and any variations thereof, are intended to cover non-exclusive inclusions, such that a process, method, article, or apparatus that comprises a list of elements is not necessarily limited to those elements, but may include other elements not expressly listed or inherent to such process, method, article, or apparatus. It is to be understood that the embodiments of the invention described herein may be used, for example, in other orientations than those illustrated or otherwise described herein. The term “coupled,” as used herein, is defined as directly or indirectly connected in an electrical or non-electrical manner.

An embodiment of a system includes an RFID tag reader and a drive system. The RFID tag reader is configured to receive an RFID tag response signal from an RFID tag, where the RFID tag reader includes a directional antenna configured to receive RF signals within a radiowave beam. The drive system is coupled to the directional antenna, and is configured to change a physical orientation of the directional antenna with respect to a fixed coordinate system, resulting in adjustments to an angular orientation of the radiowave beam with respect to the fixed coordinate system.

According to a further embodiment, the system includes a camera coupled to the drive system, and configured to capture images within a field of view and to produce image data corresponding to the images. The directional antenna and the camera are coupled to the drive system so that the radiowave beam and the field of view overlap. According to yet a further embodiment, the drive system and the camera comprise portions of a pan-tilt-zoom (PTZ) camera system.

According to another further embodiment, the drive system is configured to adjust the physical orientation of the directional antenna of the RFID tag reader in a manner that causes the radiowave beam to move through a pan angle range defined within the fixed coordinate system, and the drive system is further configured to adjust the physical orientation of the directional antenna in a manner that causes the radiowave beam to move through a tilt angle range defined within the fixed coordinate system. According to another further embodiment, the system includes a drive system controller communicatively coupled with the drive system, and configured to provide control signals to the drive system that cause the drive system to change the physical orientation of the directional antenna with respect to the fixed coordinate system.

According to another further embodiment, the RFID tag reader comprises a passive RFID tag reader, and the RFID tag reader is further configured to transmit an RFID tag interrogation signal. According to another further embodiment, the RFID tag reader comprises an active RFID tag reader.

According to another further embodiment, the directional antenna of the RFID tag reader comprises a high gain antenna, including an antenna having a gain in a range of 8 to 15 dBi.

According to another further embodiment, the RFID tag reader includes an RFID tag reader controller coupled to the directional antenna, and configured to convert the RFID tag response signal into RFID tag identifying data, and an external system interface configured to communicate the RFID tag identifying data to an external system. According to yet a further embodiment, the system includes the external system, where the external system is configured to maintain inventory information regarding quantities of a plurality of articles that are present within a controlled area based on the RFID tag identifying data received from the RFID tag reader. According to yet another further embodiment, the drive system is further configured to produce angular orientation data indicating the angular orientation of the radiowave beam with respect to the fixed coordinate system, and the external system interface is further configured to communicate the angular orientation data to the external system. According to yet a further embodiment, the system is configured to associate the RFID tag identifying data and the angular orientation data. According to yet a further embodiment, the system also includes one or more additional RFID tag readers and the external system, where the external system is configured to receive the RFID tag identifying data and the angular orientation data from the RFID tag reader and from the one or more additional RFID tag readers, and to determine a physical location of a particular RFID tag based on the RFID tag identifying data and the angular orientation data.

According to another further embodiment, the RFID tag reader includes an RFID tag reader controller, an external system interface, and a camera. The RFID tag reader controller is coupled to the directional antenna, and is configured to convert the RFID tag response signal into RFID tag identifying data. The external system interface is configured to communicate the RFID tag identifying data to an external system. The camera is coupled to the drive system, and is configured to capture images within a field of view and to produce image data corresponding to the images, where the external system interface is further configured to communicate the image data to the external system. According to yet a further embodiment, the system is configured to associate the RFID tag identifying data and the image data.

An embodiment of an RFID tag reader system includes an RFID tag reader, a camera, and a drive system. The RFID tag reader is configured to receive an RFID tag response signal from an RFID tag, and to produce RFID tag identifying data from the RFID tag response signal, where the RFID tag reader includes a directional antenna configured to receive RF signals within a radiowave beam. The camera is configured to capture images within a field of view and to produce image data corresponding to the images. The drive system is coupled to the directional antenna and to the camera, and the drive system is configured to change physical orientations of the directional antenna and the camera with respect to a fixed coordinate system, resulting in adjustments to an angular orientation of the radiowave beam and an angular orientation of the field of view with respect to the fixed coordinate system.

According to a further embodiment, the drive system is further configured to produce angular orientation data indicating the angular orientation of the radiowave beam with respect to the fixed coordinate system, and the RFID tag reader further comprises an external system interface configured to communicate the RFID tag identifying data, the angular orientation data, and the image data to an external system.

An embodiment of a method for detecting an RFID tag includes the step of changing a physical orientation of a directional antenna of an RFID tag reader with respect to a fixed coordinate system, where the directional antenna is configured to receive RF signals within a radiowave beam, and changing the physical orientation of the directional antenna results in adjustments to an angular orientation of the radiowave beam with respect to the fixed coordinate system. The method further includes receiving an RFID tag response signal from the RFID tag when the RFID tag is within an area encompassed by the radiowave beam, and producing RFID tag data based on the RFID tag response signal.

According to a further embodiment, the method also includes changing a physical orientation of a camera with respect to the fixed coordinate system, resulting in adjustments to an angular orientation of a field of view of the camera with respect to the fixed coordinate system, capturing images within the field of view, and producing image data corresponding to the images. According to yet a further embodiment, the method also includes communicating the RFID tag data and the image data to an external system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system comprising:
a radio frequency identification (RFID) tag reader configured to receive an RFID tag response signal from an RFID tag, wherein the RFID tag reader includes a directional antenna configured to receive RF signals within a radiowave beam; and
a drive system coupled to the directional antenna, and configured to change a physical orientation of the directional antenna with respect to a fixed coordinate system, resulting in adjustments to an angular orientation of the radiowave beam with respect to the fixed coordinate system.

2. The system of claim 1, further comprising:
a camera coupled to the drive system, and configured to capture images within a field of view and to produce image data corresponding to the images,
wherein the directional antenna and the camera are coupled to the drive system so that the radiowave beam and the field of view overlap.

3. The system of claim 2, wherein the drive system and the camera comprise portions of a pan-tilt-zoom (PTZ) camera system.

4. The system of claim 1, wherein the drive system is configured to adjust the physical orientation of the directional antenna of the RFID tag reader in a manner that causes the radiowave beam to move through a pan angle range defined within the fixed coordinate system, and wherein the drive system is further configured to adjust the physical orientation of the directional antenna in a manner that causes the radiowave beam to move through a tilt angle range defined within the fixed coordinate system.

5. The system of claim 1, further comprising:
a drive system controller communicatively coupled with the drive system, and configured to provide control signals to the drive system that cause the drive system to change the physical orientation of the directional antenna with respect to the fixed coordinate system.

6. The system of claim 1, wherein the RFID tag reader comprises a passive RFID tag reader, and the RFID tag reader is further configured to transmit an RFID tag interrogation signal.

7. The system of claim 1, wherein the RFID tag reader comprises an active RFID tag reader.

8. The system of claim 1, wherein the directional antenna of the RFID tag reader comprises a high gain antenna, including an antenna having a gain in a range of 8 to 15 dBi.

9. The system of claim 1, wherein the RFID tag reader comprises:
an RFID tag reader controller coupled to the directional antenna, and configured to convert the RFID tag response signal into RFID tag identifying data; and
an external system interface configured to communicate the RFID tag identifying data to an external system.

10. The system of claim 9, further comprising:
the external system, wherein the external system is configured to maintain inventory information regarding quantities of a plurality of articles that are present within a controlled area based on the RFID tag identifying data received from the RFID tag reader.

11. The system of claim 9, wherein:
the drive system is further configured to produce angular orientation data indicating the angular orientation of the radiowave beam with respect to the fixed coordinate system; and
the external system interface is further configured to communicate the angular orientation data to the external system.

12. The system of claim 11, wherein the system is configured to associate the RFID tag identifying data and the angular orientation data.

13. The system of claim 11, further comprising:
one or more additional RFID tag readers; and
the external system, wherein the external system is configured to receive the RFID tag identifying data and the angular orientation data from the RFID tag reader and from the one or more additional RFID tag readers, and to determine a physical location of a particular RFID tag based on the RFID tag identifying data and the angular orientation data.

14. The system of claim 9, further comprising:
a camera coupled to the drive system, and configured to capture images within a field of view and to produce image data corresponding to the images,
wherein the external system interface is further configured to communicate the image data to the external system.

15. The system of claim 14, wherein the system is configured to associate the RFID tag identifying data and the image data.

16. A radio frequency identification (RFID) tag reader system comprising:
an RFID tag reader configured to receive an RFID tag response signal from an RFID tag, and to produce RFID tag identifying data from the RFID tag response signal, wherein the RFID tag reader includes a directional antenna configured to receive RF signals within a radiowave beam;
a camera configured to capture images within a field of view and to produce image data corresponding to the images; and
a drive system coupled to the directional antenna and to the camera, wherein the drive system is configured to change physical orientations of the directional antenna and the camera with respect to a fixed coordinate system, resulting in adjustments to an angular orientation of the radiowave beam and an angular orientation of the field of view with respect to the fixed coordinate system.

17. The RFID tag reader system of claim 16, wherein:
the drive system is further configured to produce angular orientation data indicating the angular orientation of the radiowave beam with respect to the fixed coordinate system; and
wherein the RFID tag reader further comprises an external system interface configured to communicate the RFID tag identifying data, the angular orientation data, and the image data to an external system.

18. A method for detecting a radio frequency identification (RFID) tag, the method comprising the steps of:
changing a physical orientation of a directional antenna of an RFID tag reader with respect to a fixed coordinate system, wherein the directional antenna is configured to receive RF signals within a radiowave beam, and changing the physical orientation of the directional antenna results in adjustments to an angular orientation of the radiowave beam with respect to the fixed coordinate system;
receiving an RFID tag response signal from the RFID tag when the RFID tag is within an area encompassed by the radiowave beam; and
producing RFID tag data based on the RFID tag response signal.

19. The method of claim 18, further comprising:
changing a physical orientation of a camera with respect to the fixed coordinate system, resulting in adjustments to an angular orientation of a field of view of the camera with respect to the fixed coordinate system;
capturing images within the field of view; and
producing image data corresponding to the images.

20. The method of claim 19, further comprising communicating the RFID tag data and the image data to an external system.
